(19) United States
(12) Patent Application Publication
(10) Pub. No.: US 2026/0343567 A1
(43) Pub. Date: Oct. 29, 2026

(54) DYNAMIC HYBRID AUTOMATIC REPEAT REQUEST TIMING FOR TRANSMITTING FEEDBACK

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Giovanni CHISCI, San Diego, CA (US); Changlong XU, Beijing (CN); Shaozhen GUO, Beijing (CN); Luanxia YANG, Beijing (CN); Hao XU, Beijing (CN)

(21) Appl. No.: 19/119,607

(22) PCT Filed: Dec. 19, 2022
(86) PCT No.: PCT/CN2022/139943

§ 371 Date: Apr. 9, 2025

(51) Int. Cl. H04W 72/25; H04L 1/1829; H04L 5/00; H04W 72/0446

(52) U.S. Cl. CPC H04W 72/25; H04L 1/1854; H04L 5/0055; H04W 72/0446

(57) ABSTRACT

Various aspects of the present disclosure generally relate to wireless communication. In some aspects, a receiver user equipment (UE) may receive first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The UE may receive second SCI comprising a second dynamic SL HARQ timing offset indication comprising an applicable offset value, the applicable offset value comprising a value that is applicable for indicating a timing for transmitting SL HARQ feedback information. The UE may transmit, using a feedback time resource that is associated with the applicable offset value, first SL HARQ feedback information associated with the first SCI. Numerous other aspects are described.

### FIELD OF THE DISCLOSURE

Aspects of the present disclosure generally relate to wireless communication and to techniques and apparatuses for dynamic hybrid automatic repeat request timing for transmitting feedback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A receiver user equipment (UE) may communicate with a transmitter UE on a sidelink during a channel occupancy time (COT). The receiver UE may transmit feedback information in a slot indicated by a dynamic offset value (K1). However, due to the existence of UE processing delay, for the last few data transmissions within a COT, the corresponding feedback may be scheduled to be transmitted outside the COT. In this case, the feedback information may be reported in a following COT, which may be occupied by a non-sidelink device, resulting in feedback reporting failure.

Some aspects of the techniques and apparatuses described herein may provide a dynamic hybrid automatic repeat request (HARQ) timeline by indicating, in first sidelink control information (SCI), an inapplicable HARQ offset value K1 to indicate that the corresponding HARQ feedback information is to be held until a later time. For example, the inapplicable value may be added to the K1 value set. The dynamic feedback timing may be determined based on an applicable K1 indicated in second SCI. An inapplicable offset value K1 is a value that is not applicable for indicating a timing for transmitting sidelink (SL) HARQ feedback information. For example, in some aspects, the inapplicable offset value may be a value of −1. In this way, the HARQ feedback information may be sent during a COT occupied by the transmitter UE for which the HARQ feedback is intended, thereby mitigating the risk of HARQ-ACK reporting failure.

In some other aspects, the receiver UE may transmit the HARQ feedback information in a medium access control control element (MAC CE), thereby allowing the transmitter UE to use an applicable offset value even if the applicable offset value indicates physical sidelink feedback channel (PSFCH) resources outside of a current COT. For example, if a listen-before-talk (LBT) procedure fails before PSFCH transmission, the receiver UE may continue to perform LBT and may transmit HARQ feedback information in a MAC CE when it accesses the channel based on a successful LBT procedure.

Some aspects described herein relate to a receiver UE for wireless communication. The receiver user equipment may include a memory and one or more processors coupled to the memory. The one or more processors may be configured to receive first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The one or more processors may be configured to receive second SCI comprising a second dynamic SL HARQ timing offset indication comprising an applicable offset value, the applicable offset value comprising a value that is applicable for indicating a timing for transmitting SL HARQ feedback information. The one or more processors may be configured to transmit, using a feedback time resource that is associated with the applicable offset value, first SL HARQ feedback information associated with the first SCI.

Some aspects described herein relate to a transmitter UE for wireless communication. The transmitter user equipment may include a memory and one or more processors coupled to the memory. The one or more processors may be configured to transmit first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The one or more processors may be configured to transmit second SCI comprising a second dynamic SL HARQ timing offset indication comprising an applicable offset value, the applicable offset value comprising a value that is applicable for indicating a timing for transmitting SL HARQ feedback information. The one or more processors may be configured to receive, using a feedback time resource that is associated with the applicable offset value, first SL HARQ feedback information associated with the first SCI.

Some aspects described herein relate to a receiver UE for wireless communication. The receiver user equipment may include a memory and one or more processors coupled to the memory. The one or more processors may be configured to receive first SCI comprising a first dynamic SL HARQ timing offset indication corresponding to a physical sidelink feedback channel (PSFCH) time resource allocated for transmitting, over an unlicensed SL channel and outside of a channel occupancy time (COT), first SL HARQ feedback information associated with a first data transmission scheduled within the COT, the first dynamic HARQ timing offset indication comprising an applicable offset value. The one or more processors may be configured to perform a second listen-before-talk (LBT) procedure based on a first LBT procedure failing prior to a start of the PSFCH time resource. The one or more processors may be configured to transmit, to a transmitter UE and using a medium access control control element (MAC CE) associated with a physical sidelink shared channel (PSSCH), the first SL HARQ feedback information based on the second LBT procedure being successful.

Some aspects described herein relate to a transmitter UE for wireless communication. The transmitter user equipment may include a memory and one or more processors coupled to the memory. The one or more processors may be configured to transmit, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The one or more processors may be configured to receive, using a MAC CE associated with a PSSCH, the first SL HARQ feedback information based on a successful LBT procedure associated with the receiver UE.

Some aspects described herein relate to a method of wireless communication performed by a receiver UE. The method may include receiving first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The method may include receiving second SCI comprising a second dynamic SL HARQ timing offset indication comprising an applicable offset value, the applicable offset value comprising a value that is applicable for indicating a timing for transmitting SL HARQ feedback information offset value, the applicable offset value comprising a positive integer. The method may include transmitting, using a feedback time resource that is associated with the applicable offset value, first SL HARQ feedback information associated with the first SCI.

Some aspects described herein relate to a method of wireless communication performed by a transmitter UE. The method may include transmitting first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The method may include transmitting second SCI comprising a second dynamic SL HARQ timing offset indication comprising an applicable offset value, the applicable offset value comprising a value that is applicable for indicating a timing for transmitting SL HARQ feedback information. The method may include receiving, using a feedback time resource that is associated with the applicable offset value, first SL HARQ feedback information associated with the first SCI.

Some aspects described herein relate to a method of wireless communication performed by a receiver UE. The method may include receiving first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The method may include performing a second LBT procedure based on a first LBT procedure failing prior to a start of the PSFCH time resource. The method may include transmitting, to a transmitter UE and using a MAC CE associated with a PSSCH, the first SL HARQ feedback information based on the second LBT procedure being successful.

Some aspects described herein relate to a method of wireless communication performed by a transmitter UE. The method may include transmitting, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The method may include receiving, using a MAC CE associated with a PSSCH, the first SL HARQ feedback information based on a successful LBT procedure associated with the receiver UE.

Some aspects described herein relate to a non-transitory computer-readable medium that stores a set of instructions for wireless communication by a receiver UE. The set of instructions, when executed by one or more processors of the UE, may cause the UE to receive first SCI comprising a first dynamic SL HARQ timing offset indication for transmitting first SL HAR Q feedback information associated with a first data transmission, the first dynamic HARQ timing offset indication comprising an inapplicable offset value, the inapplicable offset value comprising a value that is not applicable for indicating a timing for transmitting SL HARQ feedback information. The set of instructions, when executed by one or more processors of the UE, may cause the UE to receive second SCI comprising a second dynamic SL HARQ timing offset indication comprising an applicable offset value, the applicable offset value comprising a value that is applicable for indicating a timing for transmitting SL HARQ feedback information. The set of instructions, when executed by one or more processors of the UE, may cause the UE to transmit, using a feedback time resource that is associated with the applicable offset value, first SL HARQ feedback information associated with the first SCI.

Some aspects described herein relate to a non-transitory computer-readable medium that stores a set of instructions for wireless communication by a transmitter UE. The set of instructions, when executed by one or more processors of the UE, may cause the UE to transmit first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The set of instructions, when executed by one or more processors of the UE, may cause the UE to transmit second SCI comprising a second dynamic SL HARQ timing offset indication comprising an applicable offset value, the applicable offset value comprising a value that is applicable for indicating a timing for transmitting SL HARQ feedback information. The set of instructions, when executed by one or more processors of the UE, may cause the UE to receive, using a feedback time resource that is associated with the applicable offset value, first SL HARQ feedback information associated with the first SCI.

Some aspects described herein relate to a non-transitory computer-readable medium that stores a set of instructions for wireless communication by an UE. The set of instructions, when executed by one or more processors of the UE, may cause the UE to receive first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The set of instructions, when executed by one or more processors of the UE, may cause the UE to perform a second LBT procedure based on a first LBT procedure failing prior to a start of the PSFCH time resource. The set of instructions, when executed by one or more processors of the UE, may cause the UE to transmit, to a transmitter UE and using a MAC CE associated with a PSSCH, the first SL HARQ feedback information based on the second LBT procedure being successful.

Some aspects described herein relate to a non-transitory computer-readable medium that stores a set of instructions for wireless communication by an UE. The set of instructions, when executed by one or more processors of the UE, may cause the UE to transmit, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The set of instructions, when executed by one or more processors of the UE, may cause the UE to receive, using a MAC CE associated with a PSSCH, the first SL HARQ feedback information based on a successful LBT procedure associated with the receiver UE.

Some aspects described herein relate to an apparatus for wireless communication. The apparatus may include means for receiving first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The apparatus may include means for receiving second SCI comprising a second dynamic SL HARQ timing offset indication comprising an applicable offset value, the applicable offset value comprising a value that is applicable for indicating a timing for transmitting SL HARQ feedback information. The apparatus may include means for transmitting, using a feedback time resource that is associated with the applicable offset value, first SL HARQ feedback information associated with the first SCI.

Some aspects described herein relate to an apparatus for wireless communication. The apparatus may include means for transmitting first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The apparatus may include means for transmitting second SCI comprising a second dynamic SL HARQ timing offset indication comprising an applicable offset value, the applicable offset value comprising a value that is applicable for indicating a timing for transmitting SL HARQ feedback information. The apparatus may include means for receiving, using a feedback time resource that is associated with the applicable offset value, first SL HARQ feedback information associated with the first SCI.

Some aspects described herein relate to an apparatus for wireless communication. The apparatus may include means for receiving first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The apparatus may include means for performing a second LBT procedure based on a first LBT procedure failing prior to a start of the PSFCH time resource. The apparatus may include means for transmitting, to a transmitter UE and using a MAC CE associated with a PSSCH, the first SL HARQ feedback information based on the second LBT procedure being successful.

Some aspects described herein relate to an apparatus for wireless communication. The apparatus may include means for transmitting, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The apparatus may include means for receiving, using a MAC CE associated with a PSSCH, the first SL HARQ feedback information based on a successful LBT procedure associated with the receiver UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of a dynamic hybrid automatic repeat request (HARQ) timeline for sidelink communications, in accordance with the present disclosure.

FIG. 5 is a diagram illustrating an example associated with dynamic HARQ timing for transmitting feedback information, in accordance with the present disclosure.

FIG. 6 is a diagram illustrating another example associated with dynamic HARQ timing for transmitting feedback information, in accordance with the present disclosure.

FIG. 7 is a diagram illustrating another example associated with dynamic HARQ timing for transmitting feedback information, in accordance with the present disclosure.

FIG. 8 is a diagram illustrating an example process performed, for example, by a receiver UE, in accordance with the present disclosure.

FIG. 9 is a diagram illustrating an example process performed, for example, by a transmitter UE, in accordance with the present disclosure.

FIG. 10 is a diagram illustrating an example process performed, for example, by a receiver UE, in accordance with the present disclosure.

FIG. 11 is a diagram illustrating an example process performed, for example, by a transmitter UE, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

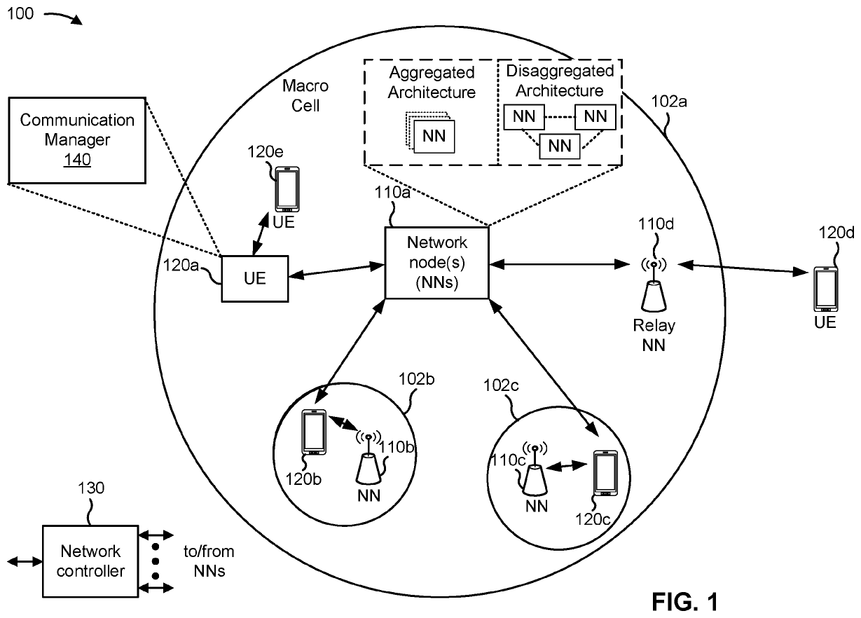

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information; receive second SCI comprising a second dynamic SL HARQ timing offset indication comprising an applicable offset value, the applicable offset value comprising a value that is applicable for indicating a timing for transmitting SL HARQ feedback information; and transmit, using a feedback time resource that is associated with the applicable offset value, first SL HARQ feedback information associated with the first SCI. Additionally, or alternatively, the communication manager 140 may perform one or more other operations described herein. In some aspects, the communication manager 140 may transmit first SCI comprising a first dynamic SL HARQ timing offset indication for transmitting first SL HARQ feedback information associated with a first data transmission, the first dynamic HARQ timing offset indication comprising a non-numerical offset value, the non-numerical offset value comprising a value other than a positive integer; transmit second SCI comprising a second dynamic SL HARQ timing offset indication comprising an applicable offset value, the numerical offset value comprising a positive integer; and receive, using a feedback time resource that is associated with the numerical offset value, first SL HARQ feedback information associated with the first SCI.

In some aspects, the communication manager 140 may receive first SCI comprising a first dynamic SL HARQ timing offset indication corresponding to a physical sidelink feedback channel (PSFCH) time resource allocated for transmitting, over an unlicensed SL channel and outside of a channel occupancy time (COT), first SL HARQ feedback information associated with a first data transmission scheduled within the COT, the first dynamic HARQ timing offset indication comprising an applicable offset value; perform a second listen-before-talk (LBT) procedure based on a first LBT procedure failing prior to a start of the PSFCH time resource; and transmit, to a transmitter UE and using a medium access control control element (MAC CE) associated with a physical sidelink shared channel (PSSCH), the first SL HARQ feedback information based on the second LBT procedure being successful. In some aspects, the communication manager 140 may transmit, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value; and receive, using a MAC CE associated with a PSSCH, the first SL HARQ feedback information based on a successful LBT procedure associated with the receiver UE. Additionally, or alternatively, the communication manager 140 may perform one or more other operations described herein.

As indicated above, FIG. 1 is provided as an example. Other examples may differ from what is described with regard to FIG. 1.

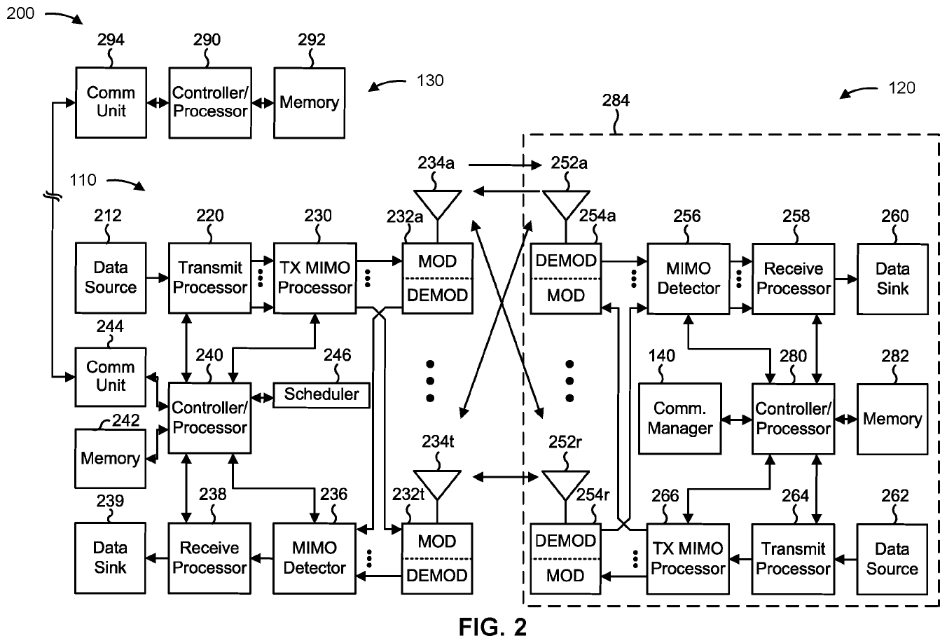

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

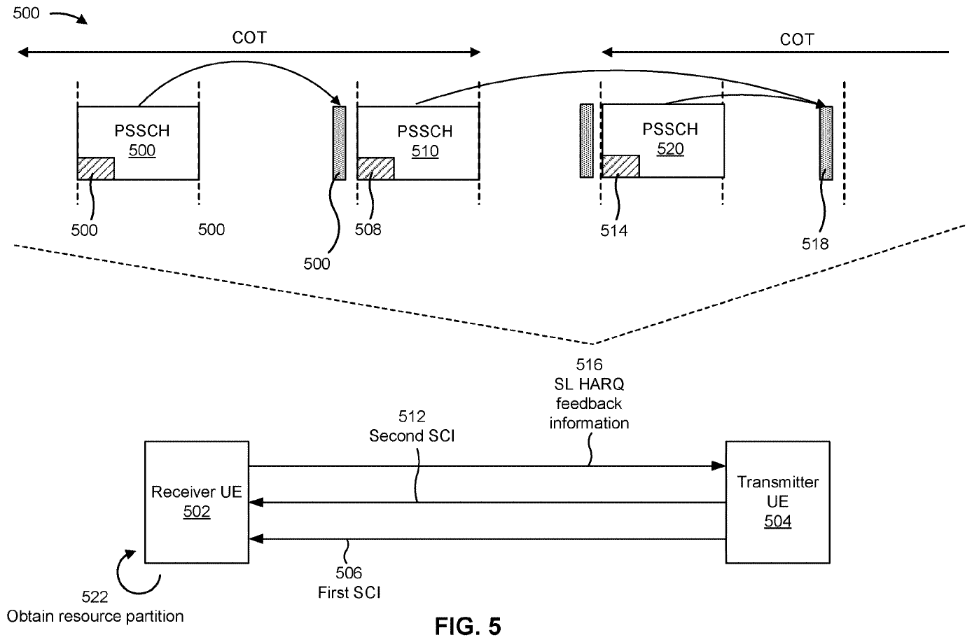

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

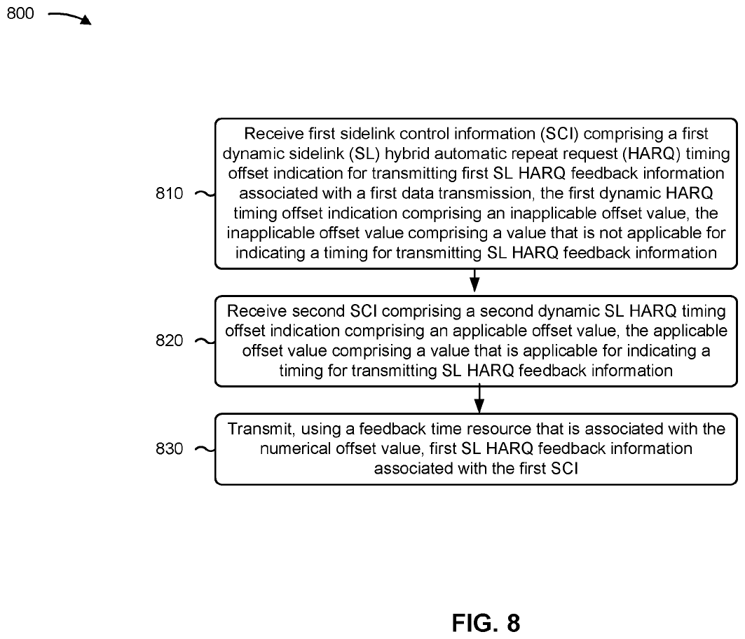

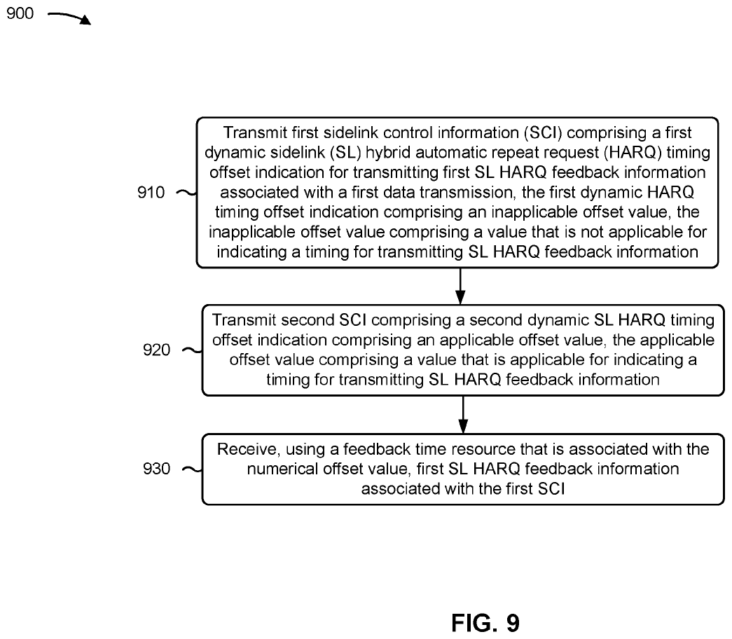

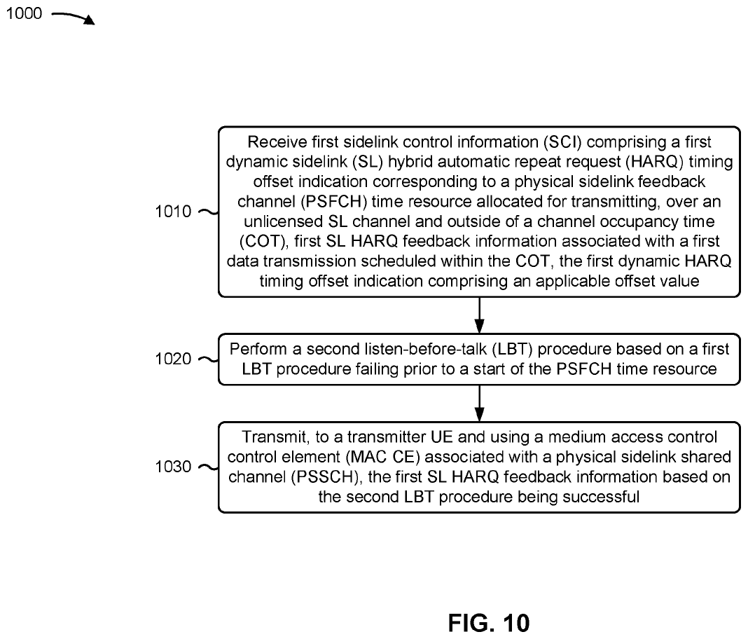

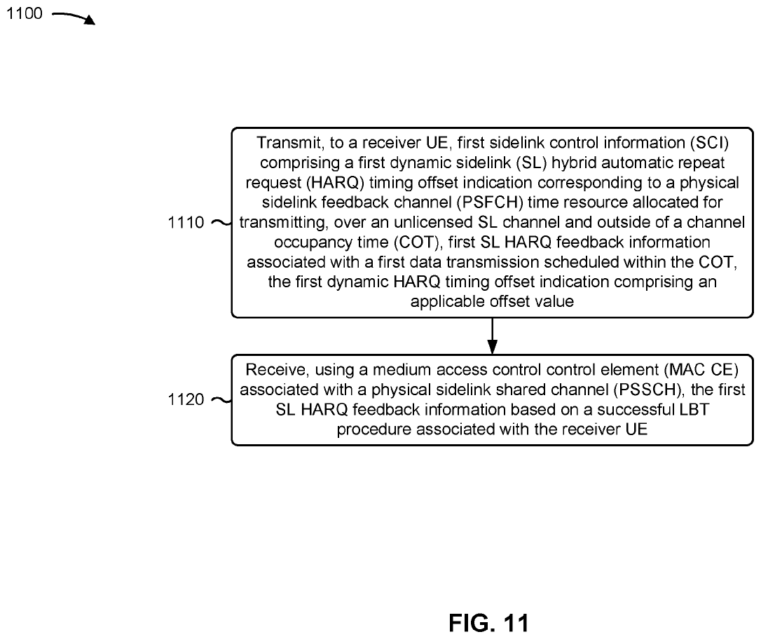

The controller/processor 240 of the network node 110, the controller/processor 280 of the UE 120, and/or any other component(s) of FIG. 2 may perform one or more techniques associated with dynamic HARQ timing for transmitting feedback, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a receiver UE (e.g., UE 120) includes means for receiving first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HAR Q feedback information; means for receiving second SCI comprising a second dynamic SL HARQ timing offset indication comprising an applicable offset value, the applicable offset value comprising a value that is applicable for indicating a timing for transmitting SL HARQ feedback information; and/or means for transmitting, using a feedback time resource that is associated with the applicable offset value, first SL HARQ feedback information associated with the first SCI.

In some aspects, the receiver UE includes means for receiving first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value; means for performing a second LBT procedure based on a first LBT procedure failing prior to a start of the PSFCH time resource; and/or means for transmitting, to a transmitter UE and using a MAC CE associated with a PSSCH, the first SL HARQ feedback information based on the second LBT procedure being successful. The means for the receiver UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a transmitter UE (e.g., UE 120) includes means for transmitting first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information; means for transmitting second SCI comprising a second dynamic SL HARQ timing offset indication comprising an applicable offset value, the applicable offset value comprising a value that is applicable for indicating a timing for transmitting SL HARQ feedback information; and/or means for receiving, using a feedback time resource that is associated with the applicable offset value, first SL HARQ feedback information associated with the first SCI.

In some aspects, the transmitter UE includes means for transmitting, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value; and/or means for receiving, using a MAC CE associated with a PSSCH, the first SL HARQ feedback information based on a successful LBT procedure associated with the receiver UE. The means for the transmitter UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

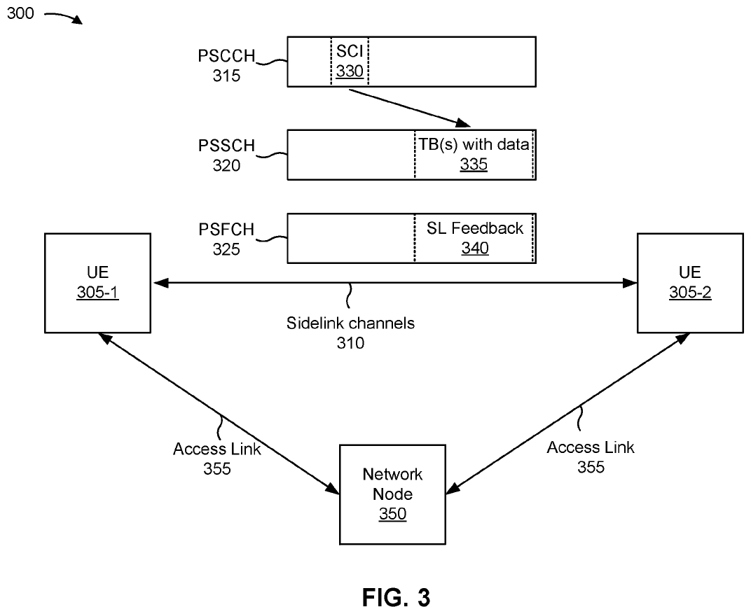

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as HARQ feedback (e.g., acknowledgement or negative acknowledgement (ACK/NACK) information), transmit power control (TPC), and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an acknowledgment (ACK) in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “SL HARQ feedback information”).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

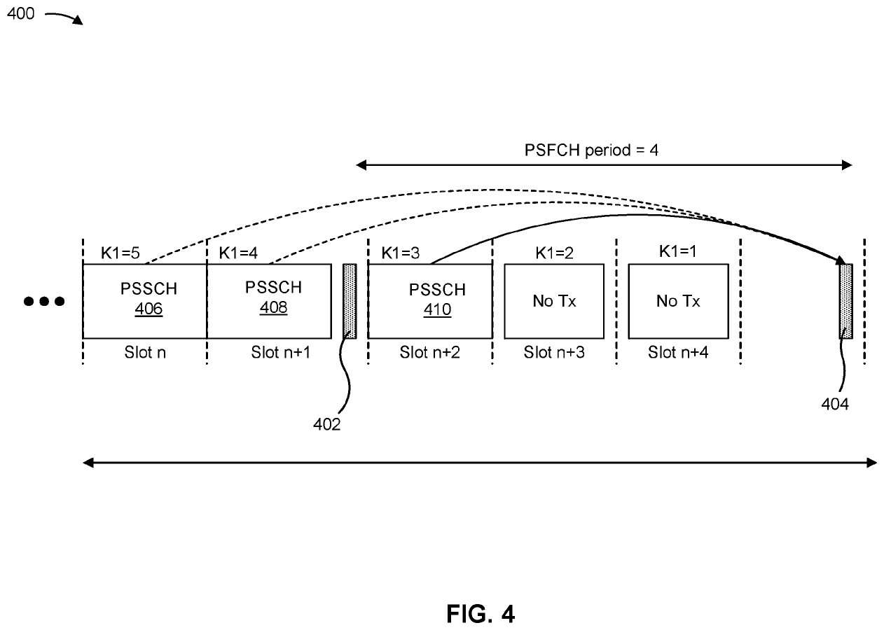

Additionally, or alternatively, as described in more detail in connection with FIGS. 4A-4C, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As shown, a network node 350 may communicate with the UE 305-1 and/or the UE 305-2 (e.g., directly or via one or more network nodes), such as via an access link 355. A direct link between the UEs 350-1 and 350-2 (e.g., via a PC5 interface) may be referred to as a sidelink, and a direct link between a network node 350 and a UE 350-1 or 350-2 (e.g., via a Uu interface) may be referred to as an access link. Sidelink communications may be transmitted via the sidelink, and access link communications may be transmitted via the access link. An access link communication may be either a downlink communication (from the network node 350 to the UE 350-1 or 350-2) or an uplink communication (from a UE 350-1 or 350-2 to the network node 350).

As indicated above, FIG. 3 is provided as an example. Other examples may differ from what is described with respect to FIG. 3.

Some aspects described herein relate to an unlicensed radio frequency spectrum band, which may be used for communications in a wireless network, such as wireless network 100. In some aspects, the unlicensed radio frequency spectrum band can be used by network nodes 110 and UEs 120 of a cellular network for cellular communications (e.g., NR communications), and/or by Wi-Fi access points and Wi-Fi stations of a Wi-Fi network for Wi-Fi communications, among other examples. The unlicensed radio frequency spectrum band can be used in the cellular network in combination with, or independent from, a licensed radio frequency spectrum band. In some examples, the unlicensed radio frequency spectrum band can be a radio frequency spectrum band for which a device may need to contend for access because the radio frequency spectrum band is available, at least in part, for unlicensed use, such as Wi-Fi use.

Prior to gaining access to, and communicating over, an unlicensed sidelink radio frequency spectrum band, a UE can perform a LBT procedure to contend for access to the unlicensed radio frequency spectrum band. An LBT procedure, sometimes referred to as a clear channel assessment (CCA) procedure, can include performing a CCA to determine whether a channel of the unlicensed sidelink radio frequency spectrum band is available. When it is determined that the channel of the unlicensed sidelink radio frequency spectrum band is not available (e.g., because another apparatus is already using the channel of the unlicensed sidelink radio frequency spectrum band), a CCA procedure can be performed for the channel again at a later time. In environments in which a UE can be starved of access to a channel of an unlicensed sidelink radio frequency spectrum band due to Wi-Fi activity, an extended CCA procedure can be employed to increase the likelihood that the UE will successfully contend for access to the channel of the unlicensed sidelink radio frequency spectrum band. An extended CCA procedure involves the performance of a random number of CCA procedures (from 1 to q), in accordance with an extended CCA counter.

Regardless of whether a single CCA procedure is performed or multiple CCA procedures are performed, each CCA procedure may include detecting or sensing an energy level on the channel of the unlicensed sidelink radio frequency spectrum band and determining whether the energy level is below a threshold. When the energy level satisfies (e.g., does not equal or exceed) the threshold, the CCA procedure is deemed to be successful and the transmitting device may gain access to the unlicensed channel for a duration that may be referred to as a channel occupancy time (COT) during which the transmitting device can perform transmissions without performing additional LBT operations. When the energy level does not satisfy the threshold, the CCA procedure is unsuccessful and contention to access the unlicensed channel may be deemed unsuccessful.

When a CCA procedure or extended CCA procedure is successful, a transmission may be made over the channel of the unlicensed sidelink radio frequency spectrum band. When a packet error is encountered (e.g., due to a collision of transmissions made by two or more transmitting apparatuses or due to poor channel conditions), a HARQ-based retransmission can be performed. In some examples, the retransmission can be modified from the original transmission using rate adaptation (e.g., based at least in part on a CQI reported by a UE).

An LBT category can define a channel sensing duration during which a UE contending for access to a channel performs a CCA procedure. The channel sensing duration can indicate a length of time during which the UE detects or senses an energy level on the channel to determine whether the energy level is less than (or equal to) a threshold. If the energy level is less than (or equal to) the threshold, then the LBT/CCA procedure is successful, and the UE transmits a communication. If the energy level is greater than (or equal to) the threshold, then the CCA procedure is unsuccessful and the UE can wait for a period of time (e.g., a backoff duration) before performing the CCA procedure again.

FIG. 4 is a diagram illustrating an example 400 of a dynamic HARQ timeline for sidelink communications, in accordance with the present disclosure. A sidelink resource pool can be configured with a PSFCH periodicity, which indicates a periodicity of PSFCH transmissions associated with the resource pool. In example 400, the resource pool is configured with a PSFCH periodicity of

$$4 ( {N}_{PSSCH}^{PSFCH} = 4 ) .$$

resources 402, 404 indicated by the PSFCH periodicity are in every fourth slot of the resource pool.

A UE may allocate a configured number of physical resource blocks (PRBs) for the PSFCH resources 402, 404. A PRB is a group of subcarriers, and may include, for example, 12 subcarriers. As mentioned above, the PSFCH resources 402, 404 may be used to transmit HARQ feedback information regarding PSSCHs received in the resource pool. Sidelink HARQ feedback information may be sequence-based, and may carry a single bit per PSSCH. Sidelink HARQ feedback information may be sent on two consecutive symbols (e.g., symbols 11 and 12 of a slot). In some cases, one symbol before and one symbol after a PSFCH occasion may be assigned to a gap. A periodicity parameter (e.g., periodPSFCHresource) may indicate the PSFCH periodicity, in terms of a number of slots, for a resource pool. For example, the PSFCH periodicity can be set to a value in the set {0, 1, 2, 4}. If the PSFCH periodicity is set to 0, PSFCH transmissions from a UE in the resource pool are disabled. In example 400, the PSFCH periodicity is set to 4, so PSFCH transmissions are performed in every fourth slot.

The UE may transmit the PSFCH in a slot indicated by a dynamic HARQ offset value (K1). As shown in Example 400, the UE may transmit sidelink HARQ feedback information associated with a PSSCH 406 using the PSFCH resources 404 based on a value of K1 being equal to 5, sidelink HARQ feedback information associated with a PSSCH 408 using the PSFCH resources 404 based on a value of K1 being equal to 4, and sidelink HARQ feedback information associated with a PSSCH 410 using the PSFCH resources 404 based on a value of K1 being equal to 3. However, due to the existence of UE processing delay, for the last few PSSCH transmissions within a current COT, the corresponding HARQ-ACK feedback will be located outside the current COT. In this case, those HARQ-ACKs may be reported in a following COT, which may be occupied by a non-sidelink device, resulting in HARQ-ACK reporting failure.

Some aspects of the techniques and apparatuses described herein may provide a dynamic HARQ timeline by indicating, in first SCI, an inapplicable HARQ offset value K1 to indicate that the corresponding HARQ feedback information is to be held until a later time. An inapplicable offset value may include a value that is not applicable for indicating a timing for transmitting SL HARQ feedback information. For example, the inapplicable value (e.g., “−1”) may be added to the K1 value set. The dynamic feedback timing may be determined based on an applicable K1 indicated in second SCI. An applicable offset value is a value that is applicable for indicating a timing for transmitting SL HARQ feedback information. For example, an inapplicable offset value K1 may be a value other than a positive integer (since a positive integer may indicate a slot offset). For example, in some aspects, the inapplicable offset value may be a value of −1. In this way, the HARQ feedback information may be sent during a COT occupied by the transmitter UE for which the HARQ feedback is intended, thereby mitigating the risk of HARQ-ACK reporting failure.

In some other aspects, the receiver UE may transmit the HARQ feedback information in a MAC CE, thereby allowing the transmitter UE to use an applicable offset value even if the applicable offset value indicates PSFCH resources outside of a current COT. For example, if LBT fails before PSFCH transmission, the receiver UE may continue to perform LBT and may transmit SL-HARQ feedback information in a MAC CE when it accesses the channel based on a successful LBT procedure.

As indicated above, FIG. 4 is provided as an example. Other examples may differ from what is described with respect to FIG. 4.

FIG. 5 is a diagram illustrating an example 500 associated with dynamic HARQ timing for transmitting feedback information, in accordance with the present disclosure. As shown, a receiver UE 502 and a transmitter UE 504 may communicate with one another. For example, the receiver UE 502 and the transmitter UE 504 may communicate with one another via a sidelink connection. In some aspects, the receiver UE 502 and/or the transmitter UE 504 may be, be similar to, include, or be included in, the UE 305-1 and/or the UE 305-2 depicted in FIG. 3 and/or the UE 120 depicted in FIGS. 1 and 2.

As shown by reference number 506, the transmitter UE 504 may transmit, and the receiver UE 502 may receive, first SCI 508. The first SCI 508 may include a first dynamic SL HARQ timing offset indication for transmitting first SL HARQ feedback information associated with a first data transmission, which may be transmitted in a first PSSCH 510 along with the first SCI 508. The first dynamic HARQ timing offset indication may include an inapplicable offset value. For example, in some aspects, if the UE 502 receives a first DCI format that the UE 502 detects in a first PDCCH monitoring occasion and includes a PDSCH-to-HARQ feedback timing indicator field providing an inapplicable value from dl-DataToUL-ACK-r16, the behavior of HARQ feedback information is to be held until a later time.

As shown by reference number 512, the transmitter UE 504 may transmit, and the receiver UE 502 may receive, second SCI 514. The second SCI 514 may include a second dynamic SL HARQ timing offset indication that includes an applicable offset value. As shown by reference number 516, the receiver UE 502 may transmit, and the transmitter UE 504 may receive, SL HARQ feedback information. The SL HARQ feedback information may be associated with the first SCI 508. As shown, the SL HARQ feedback information may be transmitted using a feedback time resource 518. The feedback time resource 518 may include one or more time resources and/or frequency resources such as, for example, a set of PRBs.

In some aspects, the receiver UE 502 also may transmit second HARQ feedback information associated with the second SCI 514 using the feedback time resource 518. The receiver UE 502 may transmit the first SL HARQ feedback information using the feedback time resource based on a first source identifier (ID) associated with the first SCI 508 being equal to a second source ID associated with the second SCI 514. In some aspects, the UE 502 may transmit the first SL HARQ feedback information using the feedback time resource 518 based on a first source ID associated with the first SCI 508 being equal to a second source ID associated with the second SCI 514 and a first destination ID associated with the first SCI 508 being equal to a second destination ID associated with the second SCI 514.

In some aspects, the receiver UE 502 may receive an SL communication (e.g., a PSSCH communication 520) that includes the second SCI 514 and data. In some aspects, the PSSCH communication 520 may include only the second SCI 514. For example, a resource allocation field included in the second SCI 514 may include filler bits (e.g., all ones). In some aspects, the second SCI 514 may be associated with an SL connection between a transmitter UE and an additional UE (not shown). In some aspects, a first destination ID associated with the first SCI 508 may be different from a second destination ID associated with the second SCI 514. In some aspects, the first SCI 508 may include a PSFCH resource indication (PRI) that indicates a set of physical resource blocks associated with the first SL HARQ feedback information. In some aspects, as shown by reference number 522, the receiver UE 502 may obtain a resource partition indication associated with the PSFCH. In some aspects, the receiver UE 502 may obtain the resource partition indication based on at least one of accessing a memory of the receiver UE 502 (e.g., where the resource partition indication is preconfigured and/or specified by a wireless communication standard) or receiving a radio resource control (RRC) message.

In some aspects, a first destination ID associated with the first SCI 508 may be different from a second destination ID associated with the second SCI 514. The first SCI 508 may indicate a first PRI that indicates a first set of physical resource blocks associated with the first SL HARQ feedback information and the second SCI 514 may indicate a second PRI that indicates a second set of physical resource blocks associated with second SL HARQ feedback information corresponding to the SL connection between the transmitter UE and the additional UE. In some aspects, a first HARQ codebook may be associated with the first SL HARQ feedback information and a second HARQ codebook may be associated with second SL HARQ feedback information associated with the second SCI 514. In some aspects, the second HARQ codebook may include a semi-static HARQ codebook or a dynamic HARQ codebook and the second SCI 514 may include a first detected SCI having an applicable offset indication.

As indicated above, FIG. 5 is provided as an example. Other examples may differ from what is described with respect to FIG. 5.

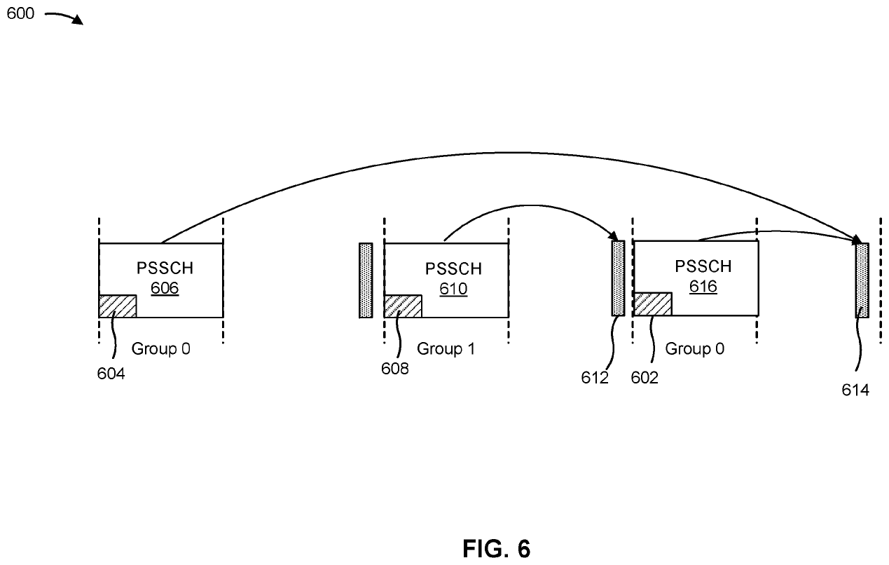

FIG. 6 is a diagram illustrating another example 600 associated with dynamic HARQ timing for transmitting feedback information, in accordance with the present disclosure. For example, the communications depicted in FIG. 6 may correspond to the receiver UE 502 and the transmitter UE 504 depicted in FIG. 5.

In some aspects, a second HARQ codebook associated with second SCI (e.g., the second SCI 514) may include an enhanced dynamic HARQ codebook. In some aspects, as shown, the second SCI may be a first detected SCI 602 having an applicable offset indication based on the first detected SCI 602 indicating a PSSCH group index that is equal to a PSSCH group index (shown as “Group 0”) indicated by the first SCI 604. Thus, as shown, for example, the receiver UE 502 may hold SL HARQ feedback information associated with the first SCI 604 (e.g., feedback information associated with reception of a data communication corresponding to the PSSCH 606) based on an inapplicable offset value K1 indicated in the first SCI 604. The receiver UE 502 may transmit SL HARQ feedback information associated with SCI 608 (e.g., feedback information associated with reception of a data communication corresponding to the PSSCH 610) in a feedback resource 612 based on an applicable offset value K1 and based on the PSSCH group index (shown as “Group 1”) being different from the PSSCH group index associated with the first SCI 604. The receiver UE 502 may transmit the SL HARQ feedback associated with the first SCI 604 in a feedback resource 614 associated with an applicable offset value K1 indicated in the SCI 602 and based on the PSSCH group index associated with the SCI 602 being the same as the PSSCH group index associated with the SCI 604 (Group 0). In some aspects, as shown, the receiver UE 502 also may transmit SL HARQ feedback information associated with the SCI 602 (e.g., feedback information associated with reception of a data communication corresponding to the PSSCH 616) using the feedback resource 614.

As indicated above, FIG. 6 is provided as an example. Other examples may differ from what is described with respect to FIG. 6.

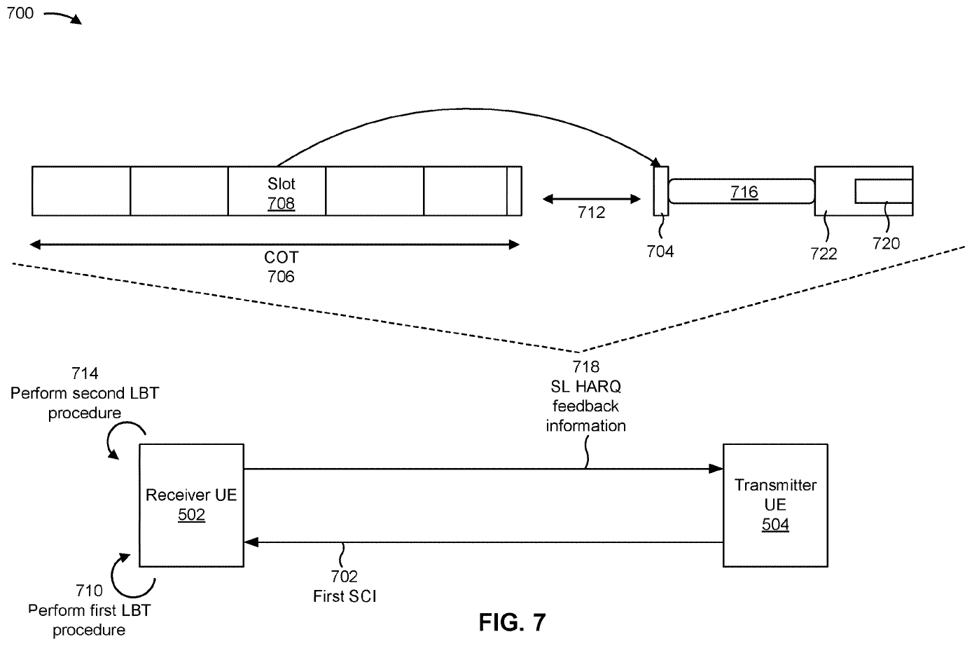

FIG. 7 is a diagram illustrating another example 700 associated with dynamic HARQ timing for transmitting feedback information, in accordance with the present disclosure. For example, as shown, the communications depicted in FIG. 7 may correspond to the receiver UE 502 and the transmitter UE 504 depicted in FIG. 5.

As shown by reference number 702, the transmitter UE 504 may transmit, and the receiver UE 502 may receive, first SCI. The first SCI may include a first dynamic SL HARQ timing offset indication corresponding to a PSFCH time resource 704 allocated for transmitting, over an unlicensed SL channel and outside of COT 706, first SL HARQ feedback information associated with a first data transmission scheduled within the COT (e.g., a transmission received in a slot 708). In some aspects, the first dynamic HARQ timing offset indication may include an applicable offset value (e.g., K1>=0). As shown by reference number 710, the receiver UE 502 may perform a first LBT procedure. The first LBT procedure may fail during a time period 712 prior to the occurrence of the PSFCH time resource 704.

As shown by reference number 714, the receiver UE 502 may perform a second LBT procedure based on the first LBT procedure failing prior to the start of the PSFCH time resource 704. In some aspects, the receiver UE 502 may continue to perform the LBT (e.g., during a time period 716) until the LBT is successful. As shown by reference number 718, the receiver UE 502 may transmit, and the transmitter UE 504 may receive, SL HARQ feedback information. The SL HARQ feedback information may be transmitted using a MAC CE 720 associated with a PSSCH 722. The receiver UE 502 may transmit the first SL HARQ feedback information based on the second LBT procedure being successful.

In some aspects, the receiver UE 502 may transmit the first SL HARQ feedback information using the MAC CE 720 based on a second stage SCI (SCI-2) communication associated with the PSSCH 722 including a destination ID corresponding to the transmitter UE 504. In some aspects, the SCI-2 communication associated with the PSSCH 722 may include a destination ID corresponding to an additional UE (not shown). In some aspects, the SCI-2 communication may include a decode indication that indicates that the transmitter UE 504 is to decode the SCI-2 communication even though the destination ID does not match the destination ID of the transmitter UE 504. In some aspects, the MAC CE may be transmitted with a data communication. In some other aspects, the MAC CE may be transmitted with a dummy data communication (e.g., a communication that does not include useful data).

As indicated above, FIG. 7 is provided as an example. Other examples may differ from what is described with respect to FIG. 7.

FIG. 8 is a diagram illustrating an example process 800 performed, for example, by a receiver UE, in accordance with the present disclosure. Example process 800 is an example where the receiver UE (e.g., receiver UE 502) performs operations associated with dynamic HARQ timing for transmitting feedback.

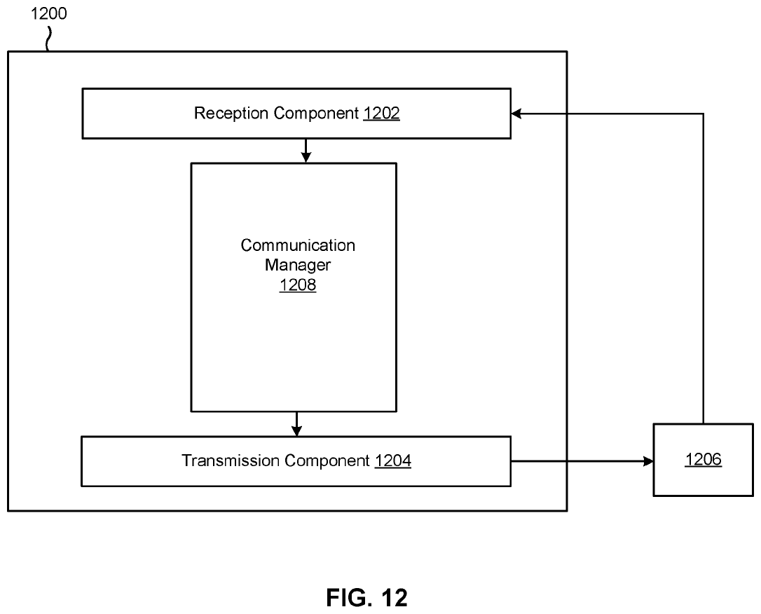

As shown in FIG. 8, in some aspects, process 800 may include receiving first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HAR Q feedback information (block 810). For example, the UE (e.g., using communication manager 1208 and/or reception component 1202, depicted in FIG. 12) may receive first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information, as described above.

As further shown in FIG. 8, in some aspects, process 800 may include receiving second SCI comprising a second dynamic SL HARQ timing offset indication comprising a numerical offset value, the numerical offset value comprising a positive integer (block 820). For example, the UE (e.g., using communication manager 1208 and/or reception component 1202, depicted in FIG. 12) may receive second SCI comprising a second dynamic SL HARQ timing offset indication comprising an applicable offset value, the applicable offset value comprising a value that is applicable for indicating a timing for transmitting SL HARQ feedback information, as described above.

As further shown in FIG. 8, in some aspects, process 800 may include transmitting, using a feedback time resource that is associated with the numerical offset value, first SL HARQ feedback information associated with the first SCI (block 830). For example, the UE (e.g., using communication manager 1208 and/or transmission component 1204, depicted in FIG. 12) may transmit, using a feedback time resource that is associated with the applicable offset value, first SL HARQ feedback information associated with the first SCI, as described above.

Process 800 may include additional aspects, such as any single aspect or any combination of aspects described below and/or in connection with one or more other processes described elsewhere herein.

In a first aspect, process 800 includes transmitting, using the feedback time resource, second SL HARQ feedback information associated with the second SCI.

In a second aspect, alone or in combination with the first aspect, transmitting the first SL HARQ feedback information using the feedback time resource comprises transmitting the first SL HARQ feedback information using the feedback time resource based on a first source ID associated with the first SCI being equal to a second source ID associated with the second SCI. In a third aspect, alone or in combination with one or more of the first and second aspects, transmitting the first SL HARQ feedback information using the feedback time resource comprises transmitting the first SL HARQ feedback information using the feedback time resource based on a first source ID associated with the first SCI being equal to a second source ID associated with the second source ID and a first destination ID associated with the first SCI being equal to a second destination ID associated with the second SCI.

In a fourth aspect, alone or in combination with one or more of the first through third aspects, receiving the second SCI comprises receiving an SL communication that includes the second SCI and data. In a fifth aspect, alone or in combination with one or more of the first through fourth aspects, receiving the second SCI comprises receiving a PSSCH communication in a corresponding slot, the PSSCH communication comprising only the second SCI. In a sixth aspect, alone or in combination with one or more of the first through fourth aspects, receiving the second SCI comprises receiving a PSSCH communication in a corresponding slot, the PSSCH communication comprising the second SCI and the first data transmission.

In a seventh aspect, alone or in combination with one or more of the first through fourth aspects, the second SCI is associated with an SL connection between a transmitter UE and an additional UE. In an eighth aspect, alone or in combination with the seventh aspect, a first destination ID associated with the first SCI is different from a second destination ID associated with the second SCI. In a ninth aspect, alone or in combination with one or more of the seventh or eighth aspects, the first SCI includes a PRI that indicates a set of physical resource blocks associated with the first SL HARQ feedback information. In a tenth aspect, alone or in combination with the ninth aspect, process 800 includes obtaining a resource partition indication associated with the PSFCH. In an eleventh aspect, alone or in combination with the tenth aspect, obtaining the resource partition indication comprises at least one of accessing a memory of the receiver UE or receiving an RRC message. In a twelfth aspect, alone or in combination with one or more of the ninth through eleventh aspects, a first destination ID associated with the first SCI is different from a second destination ID associated with the second SCI, wherein the first SCI indicates a first PRI that indicates a first set of physical resource blocks associated with the first SL HARQ feedback information, and wherein the second SCI indicates a second PRI that indicates a second set of physical resource blocks associated with second SL HARQ feedback information corresponding to the SL connection between the transmitter UE and the additional UE.

In a thirteenth aspect, alone or in combination with one or more of the first through twelfth aspects, a first HARQ codebook is associated with the first SL HARQ feedback information and a second HARQ codebook is associated with second SL HARQ feedback information associated with the second SCI. In a fourteenth aspect, alone or in combination with the thirteenth aspect, the second HARQ codebook comprises a semi-static HARQ codebook or a dynamic HARQ codebook, and wherein the second SCI comprises a first detected SCI having an applicable offset indication. In a fifteenth aspect, alone or in combination with the thirteenth aspect, the second HARQ codebook comprises an enhanced dynamic HARQ codebook, and wherein the second SCI comprises a first detected SCI having an applicable offset indication based on the first detected SCI indicating a PSSCH group index that is equal to a PSSCH group index indicated by the first SCI. In a sixteenth aspect, alone or in combination with one or more of the first through fifteenth aspects, the applicable offset value includes a positive integer and the inapplicable offset value includes a value other than a positive integer.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a transmitter UE, in accordance with the present disclosure. Example process 900 is an example where the transmitter UE (e.g., UE 504) performs operations associated with dynamic HARQ timing for transmitting feedback.

As shown in FIG. 9, in some aspects, process 900 may include transmitting first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information (block 910). For example, the UE (e.g., using communication manager 1208 and/or transmission component 1204, depicted in FIG. 12) may transmit first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information, as described above.

As further shown in FIG. 9, in some aspects, process 900 may include transmitting second SCI comprising a second dynamic SL HARQ timing offset indication comprising an applicable offset value, the numerical offset value comprising a positive integer (block 920). For example, the UE (e.g., using communication manager 1208 and/or transmission component 1204, depicted in FIG. 12) may transmit second SCI comprising a second dynamic SL HARQ timing offset indication comprising a numerical offset value, the applicable offset value comprising a value that is applicable for indicating a timing for transmitting SL HARQ feedback information, as described above.

As further shown in FIG. 9, in some aspects, process 900 may include receiving, using a feedback time resource that is associated with the applicable offset value, first SL HARQ feedback information associated with the first SCI (block 930). For example, the UE (e.g., using communication manager 1208 and/or reception component 1202, depicted in FIG. 12) may receive, using a feedback time resource that is associated with the applicable offset value, first SL HARQ feedback information associated with the first SCI, as described above.

Process 900 may include additional aspects, such as any single aspect or any combination of aspects described below and/or in connection with one or more other processes described elsewhere herein.

In a first aspect, process 900 includes receiving, using the feedback time resource, second SL HARQ feedback information associated with the second SCI. In a second aspect, alone or in combination with the first aspect, receiving the first SL HARQ feedback information using the feedback time resource comprises receiving the first SL HARQ feedback information using the feedback time resource based on a first source ID associated with the first SCI being equal to a second source ID associated with the SCI. In a third aspect, alone or in combination with one or more of the first and second aspects, receiving the first SL HARQ feedback information using the feedback time resource comprises receiving the first SL HARQ feedback information using the feedback time resource based on a first source ID associated with the first SCI being equal to a second source ID associated with the second source ID and a first destination ID associated with the first SCI being equal to a second destination ID associated with the second SCI. In a fourth aspect, alone or in combination with one or more of the first through third aspects, transmitting the second SCI comprises transmitting an SL communication that includes the second SCI and data.

In a fifth aspect, alone or in combination with one or more of the first through fourth aspects, transmitting the second SCI comprises transmitting a PSSCH communication in a corresponding slot, the PSSCH communication comprising only the second SCI. In a sixth aspect, alone or in combination with one or more of the first through fourth aspects, transmitting the second SCI comprises transmitting a PSSCH communication in a corresponding slot, the PSSCH communication comprising the second SCI and the first data transmission. In a seventh aspect, alone or in combination with one or more of the first through sixth aspects, the second SCI is associated with an SL connection between the transmitter UE and an additional UE. In an eighth aspect, alone or in combination with the seventh aspect, a first destination ID associated with the first SCI is different from a second destination ID associated with the second SCI. In a ninth aspect, alone or in combination with one or more of the seventh or eighth aspects, the first SCI includes a PRI that indicates a set of physical resource blocks associated with the first SL HARQ feedback information.

In a tenth aspect, alone or in combination with the ninth aspect, a first destination ID associated with the first SCI is different from a second destination ID associated with the second SCI, wherein the first SCI indicates a first PRI that indicates a first set of physical resource blocks associated with the first SL HARQ feedback information, and wherein the second SCI indicates a second PRI that indicates a second set of physical resource blocks associated with second SL HARQ feedback information corresponding to the SL connection between the transmitter UE and the additional UE. In an eleventh aspect, alone or in combination with one or more of the first through tenth aspects, a first HARQ codebook is associated with the first SL HARQ feedback information and a second HARQ codebook is associated with second SL HARQ feedback information associated with the second SCI. In a twelfth aspect, alone or in combination with the eleventh aspect, the second HARQ codebook comprises a semi-static HARQ codebook or a dynamic HARQ codebook, and wherein the second SCI comprises a first detected SCI having an applicable offset indication. In a thirteenth aspect, alone or in combination with the eleventh aspect, the second HARQ codebook comprises an enhanced dynamic HARQ codebook, and wherein the second SCI comprises a first detected SCI having an applicable offset indication based on the first detected SCI indicating a PSSCH group index that is equal to a PSSCH group index indicated by the first SCI. In a fourteenth aspect, alone or in combination with one or more of the first through thirteenth aspects, the applicable offset value includes a positive integer and the inapplicable offset value includes a value other than a positive integer.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a receiver UE, in accordance with the present disclosure. Example process 1000 is an example where the receiver UE (e.g., receiver UE 502) performs operations associated with dynamic HARQ timing for transmitting feedback.

As shown in FIG. 10, in some aspects, process 1000 may include receiving first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value (block 1010). For example, the receiver UE (e.g., using communication manager 1208 and/or reception component 1202, depicted in FIG. 12) may receive first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising the applicable offset value, as described above.

As further shown in FIG. 10, in some aspects, process 1000 may include performing a second LBT procedure based on a first LBT procedure failing prior to a start of the PSFCH time resource (block 1020). For example, the UE (e.g., using communication manager 1208, reception component 1202, and/or transmission component 1204, depicted in FIG. 12) may perform a second LBT procedure based on a first LBT procedure failing prior to a start of the PSFCH time resource, as described above.

As further shown in FIG. 10, in some aspects, process 1000 may include transmitting, to a transmitter UE and using a MAC CE associated with a PSSCH, the first SL HARQ feedback information based on the second LBT procedure being successful (block 1030). For example, the receiver UE (e.g., using communication manager 1208 and/or transmission component 1204, depicted in FIG. 12) may transmit, to a transmitter UE and using a MAC CE associated with a PSSCH, the first SL HARQ feedback information based on the second LBT procedure being successful, as described above.

Process 1000 may include additional aspects, such as any single aspect or any combination of aspects described below and/or in connection with one or more other processes described elsewhere herein.

In a first aspect, transmitting the first SL HARQ feedback information using the MAC CE comprises transmitting the first SL HARQ feedback information using the MAC CE based on a second stage SCI (SCI-2) communication associated with the PSSCH comprising a destination ID corresponding to the transmitter UE. In a second aspect, alone or in combination with the first aspect, a second stage SCI (SCI-2) communication associated with the PSSCH comprises a destination ID corresponding to an additional UE. In a third aspect, alone or in combination with the second aspect, the SCI-2 communication includes a decode indication. In a fourth aspect, alone or in combination with one or more of the first through third aspects, process 1000 includes transmitting, with the MAC CE, a data communication associated with the PSSCH. In a fifth aspect, alone or in combination with one or more of the first through third aspects, process 1000 includes transmitting, with the MAC CE, a dummy data communication associated with the PSSCH.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a transmitter UE, in accordance with the present disclosure. Example process 1100 is an example where the transmitter UE (e.g., UE 504) performs operations associated with dynamic HARQ timing for transmitting feedback.

As shown in FIG. 11, in some aspects, process 1100 may include transmitting, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value (block 1110). For example, the transmitter UE (e.g., using communication manager 1208 and/or transmission component 1204, depicted in FIG. 12) may transmit, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value, as described above.

As further shown in FIG. 11, in some aspects, process 1100 may include receiving, using a MAC CE associated with a PSSCH, the first SL HARQ feedback information based on a successful LBT procedure associated with the receiver UE (block 1120). For example, the transmitter UE (e.g., using communication manager 1208 and/or reception component 1202, depicted in FIG. 12) may receive, using a MAC CE associated with a PSSCH, the first SL HARQ feedback information based on a successful LBT procedure associated with the receiver UE, as described above.

Process 1100 may include additional aspects, such as any single aspect or any combination of aspects described below and/or in connection with one or more other processes described elsewhere herein.

In a first aspect, receiving the first SL HARQ feedback information using the MAC CE comprises receiving the first SL HARQ feedback information using the MAC CE based on a second stage SCI (SCI-2) communication associated with the PSSCH comprising a destination ID corresponding to the transmitter UE. In a second aspect, alone or in combination with the first aspect, a second stage SCI (SCI-2) communication associated with the PSSCH comprises a destination ID corresponding to an additional UE. In a third aspect, alone or in combination with the second aspect, the SCI-2 communication includes a decode indication. In a fourth aspect, alone or in combination with one or more of the first through third aspects, process 1100 includes receiving, with the MAC CE, a data communication associated with the PSSCH. In a fifth aspect, alone or in combination with one or more of the first through third aspects, process 1100 includes receiving, with the MAC CE, a dummy data communication associated with the PSSCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., a receiver UE or a transmitter UE), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208.

In some aspects, the apparatus 1200 may be configured to perform one or more operations described herein in connection with FIGS. 5-7. Additionally, or alternatively, the apparatus 1200 may be configured to perform one or more processes described herein, such as process 800 of FIG. 8, process 900 of FIG. 9, process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, transmitting, obtaining, and/or performing, may include various processing system components, such as a receive processor, a transmit processor, a controller/processor, a memory, or a combination thereof, of the UE described above in connection with FIG. 2.

The communication manager 1208 and/or the reception component 1202 may receive first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. In some aspects, the communication manager 1208 may include one or more antennas, a modem, a controller/processor, a memory, or a combination thereof, of the UE described in connection with FIG. 2. In some aspects, the communication manager 1208 may include the reception component 1202 and/or the transmission component 1204. In some aspects, the communication manager 1208 may be, be similar to, include, or be included in, the communication manager 140 depicted in FIGS. 1 and 2. The communication manager 1208 and/or the reception component 1202 may receive second SCI comprising a second dynamic SL HARQ timing offset indication comprising an applicable offset value, the applicable offset value comprising a value that is applicable for indicating a timing for transmitting SL HARQ feedback information. The communication manager 1208 and/or the transmission component 1204 may transmit, using a feedback time resource that is associated with the numerical offset value, first SL HARQ feedback information associated with the first SCI. The communication manager 1208 and/or the transmission component 1204 may transmit, using the feedback time resource, second SL HARQ feedback information associated with the second SCI. The communication manager 1208, the reception component 1202, and/or the transmission component 1204, may obtain a resource partition indication associated with the PSFCH.

The communication manager 1208 and/or the transmission component 1204 may transmit first SCI comprising a first dynamic SL HARQ timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information. The communication manager 1208 and/or the transmission component 1204 may transmit second SCI comprising a second dynamic SL HARQ timing offset indication comprising an applicable offset value, the applicable offset value comprising a value that is applicable for indicating a timing for transmitting SL HARQ feedback information. The communication manager 1208 and/or the reception component 1202 may receive, using a feedback time resource that is associated with the applicable offset value, first SL HARQ feedback information associated with the first SCI. The communication manager 1208 and/or the reception component 1202 may receive, using the feedback time resource, second SL HARQ feedback information associated with the second SCI.

The communication manager 1208 and/or the reception component 1202 may receive first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The communication manager 1208, the reception component 1202, and/or the transmission component 1204 may perform a second LBT procedure based on a first LBT procedure failing prior to a start of the PSFCH time resource. The communication manager 1208 and/or the transmission component 1204 may transmit, to a transmitter UE and using a MAC CE associated with a PSSCH, the first SL HARQ feedback information based on the second LBT procedure being successful. The communication manager 1208 and/or the transmission component 1204 may transmit, with the MAC CE, a data communication associated with the PSSCH. The communication manager 1208 and/or the transmission component 1204 may transmit, with the MAC CE, a dummy data communication associated with the PSSCH.

The communication manager 1208 and/or the transmission component 1204 may transmit, to a receiver UE, first SCI comprising a first dynamic SL HARQ timing offset indication corresponding to a PSFCH time resource allocated for transmitting, over an unlicensed SL channel and outside of a COT, first SL HARQ feedback information associated with a first data transmission scheduled within the COT, the first dynamic HARQ timing offset indication comprising an applicable offset value. The communication manager 1208 and/or the reception component 1202 may receive, using a MAC CE associated with a PSSCH, the first SL HARQ feedback information based on a successful LBT procedure associated with the receiver UE. The communication manager 1208 and/or the reception component 1202 may receive, with the MAC CE, a data communication associated with the PSSCH. The communication manager 1208 and/or the reception component 1202 may receive, with the MAC CE, a dummy data communication associated with the PSSCH.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a receiver user equipment (UE), comprising: receiving first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information; receiving second SCI comprising a second dynamic SL HARQ timing offset indication comprising an applicable offset value, the applicable offset value comprising a value that is applicable for indicating a timing for transmitting SL HARQ feedback information; and transmitting, using a feedback time resource that is associated with the applicable offset value, first SL HARQ feedback information associated with the first SCI.
Aspect 2: The method of Aspect 1, further comprising transmitting, using the feedback time resource, second SL HARQ feedback information associated with the second SCI.
Aspect 3: The method of either of claim 1 or 2, wherein transmitting the first SL HARQ feedback information using the feedback time resource comprises transmitting the first SL HARQ feedback information using the feedback time resource based on a first source identifier (ID) associated with the first SCI being equal to a second source ID associated with the second SCI.
Aspect 4: The method of any of Aspects 1-3, wherein transmitting the first SL HARQ feedback information using the feedback time resource comprises transmitting the first SL HARQ feedback information using the feedback time resource based on a first source identifier (ID) associated with the first SCI being equal to a second source ID associated with the second source ID and a first destination ID associated with the first SCI being equal to a second destination ID associated with the second SCI.
Aspect 5: The method of any of Aspects 1-4, wherein receiving the second SCI comprises receiving an SL communication that includes the second SCI and data.
Aspect 6: The method of any of Aspects 1-5, wherein receiving the second SCI comprises receiving a physical sidelink shared channel (PSSCH) communication in a corresponding slot, the PSSCH communication comprising only the second SCI.
Aspect 7: The method of any of Aspects 1-5, wherein receiving the second SCI comprises receiving a physical sidelink shared channel (PSSCH) communication in a corresponding slot, the PSSCH communication comprising the second SCI and the first data transmission.
Aspect 8: The method of any of Aspects 1-5, wherein the second SCI is associated with an SL connection between a transmitter UE and an additional UE.
Aspect 9: The method of Aspect 8, wherein a first destination identifier (ID) associated with the first SCI is different from a second destination ID associated with the second SCI.
Aspect 10: The method of either of claim 8 or 9, wherein the first SCI includes a physical sidelink feedback channel (PSFCH) resource indication (PRI) that indicates a set of physical resource blocks associated with the first SL HARQ feedback information.
Aspect 11: The method of Aspect 10, further comprising obtaining a resource partition indication associated with the PSFCH.
Aspect 12: The method of Aspect 11, wherein obtaining the resource partition indication comprises at least one of accessing a memory of the receiver UE or receiving a radio resource control message.
Aspect 13: The method of any of Aspects 10-12, wherein a first destination identifier (ID) associated with the first SCI is different from a second destination ID associated with the second SCI, wherein the first SCI indicates a first physical sidelink feedback channel (PSFCH) resource indication (PRI) that indicates a first set of physical resource blocks associated with the first SL HARQ feedback information, and wherein the second SCI indicates a second PRI that indicates a second set of physical resource blocks associated with second SL HARQ feedback information corresponding to the SL connection between the transmitter UE and the additional UE.
Aspect 14: The method of any of Aspects 1-13, wherein a first HARQ codebook is associated with the first SL HARQ feedback information and a second HARQ codebook is associated with second SL HARQ feedback information associated with the second SCI.
Aspect 15: The method of Aspect 14, wherein the second HARQ codebook comprises a semi-static HARQ codebook or a dynamic HARQ codebook, and wherein the second SCI comprises a first detected SCI having an applicable offset indication.
Aspect 16: The method of any of Aspects 14-15, wherein the second HARQ codebook comprises an enhanced dynamic HARQ codebook, and wherein the second SCI comprises a first detected SCI having an applicable offset indication based on the first detected SCI indicating a physical sidelink shared channel (PSSCH) group index that is equal to a PSSCH group index indicated by the first SCI.
Aspect 17: A method of wireless communication performed by a transmitter user equipment (UE), comprising: transmitting first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information; transmitting second SCI comprising a second dynamic SL HARQ timing offset indication comprising an applicable offset value, the applicable offset value comprising a value that is applicable for indicating a timing for transmitting SL HARQ feedback information; and receiving, using a feedback time resource that is associated with the applicable offset value, first SL HARQ feedback information associated with the first SCI.
Aspect 18: The method of Aspect 17, further comprising receiving, using the feedback time resource, second SL HARQ feedback information associated with the second SCI.
Aspect 19: The method of either of claim 17 or 18, wherein receiving the first SL HARQ feedback information using the feedback time resource comprises receiving the first SL HARQ feedback information using the feedback time resource based on a first source identifier (ID) associated with the first SCI being equal to a second source ID associated with the second SCI.
Aspect 20: The method of any of Aspects 17-19, wherein receiving the first SL HARQ feedback information using the feedback time resource comprises receiving the first SL HARQ feedback information using the feedback time resource based on a first source identifier (ID) associated with the first SCI being equal to a second source ID associated with the second source ID and a first destination ID associated with the first SCI being equal to a second destination ID associated with the second SCI.
Aspect 21: The method of any of Aspects 17-20, wherein transmitting the second SCI comprises transmitting an SL communication that includes the second SCI and data.
Aspect 22: The method of any of Aspects 17-20, wherein transmitting the second SCI comprises transmitting a physical sidelink shared channel (PSSCH) communication in a corresponding slot, the PSSCH communication comprising only the second SCI.
Aspect 23: The method of any of Aspects 17-20, wherein transmitting the second SCI comprises transmitting a physical sidelink shared channel (PSSCH) communication in a corresponding slot, the PSSCH communication comprising the second SCI and the first data transmission.
Aspect 24: The method of any of Aspects 17-23, wherein the second SCI is associated with an SL connection between the transmitter UE and an additional UE.
Aspect 25: The method of Aspect 24, wherein a first destination identifier (ID) associated with the first SCI is different from a second destination ID associated with the second SCI.
Aspect 26: The method of either of claim 24 or 25, wherein the first SCI includes a physical sidelink feedback channel (PSFCH) resource indication (PRI) that indicates a set of physical resource blocks associated with the first SL HARQ feedback information.
Aspect 27: The method of Aspect 26, wherein a first destination identifier (ID) associated with the first SCI is different from a second destination ID associated with the second SCI, wherein the first SCI indicates a first physical sidelink feedback channel (PSFCH) resource indication (PRI) that indicates a first set of physical resource blocks associated with the first SL HARQ feedback information, and wherein the second SCI indicates a second PRI that indicates a second set of physical resource blocks associated with second SL HARQ feedback information corresponding to the SL connection between the transmitter UE and the additional UE.
Aspect 28: The method of any of Aspects 17-27, wherein a first HARQ codebook is associated with the first SL HARQ feedback information and a second HARQ codebook is associated with second SL HARQ feedback information associated with the second SCI.
Aspect 29: The method of Aspect 28, wherein the second HARQ codebook comprises a semi-static HARQ codebook or a dynamic HARQ codebook, and wherein the second SCI comprises a first detected SCI having an applicable offset indication.
Aspect 30: The method of any of Aspects 28-29, wherein the second HARQ codebook comprises an enhanced dynamic HARQ codebook, and wherein the second SCI comprises a first detected SCI having an applicable offset indication based on the first detected SCI indicating a physical sidelink shared channel (PSSCH) group index that is equal to a PSSCH group index indicated by the first SCI.
Aspect 31: A method of wireless communication performed by a receiver user equipment (UE), comprising: receiving first sidelink control information (SCI) comprising a first dynamic sidelink (SL) hybrid automatic repeat request (HARQ) timing offset indication corresponding to a physical sidelink feedback channel (PSFCH) time resource allocated for transmitting, over an unlicensed SL channel and outside of a channel occupancy time (COT), first SL HARQ feedback information associated with a first data transmission scheduled within the COT, the first dynamic HARQ timing offset indication comprising an applicable offset value, the applicable offset value comprising a value that is applicable for indicating a timing for transmitting SL HARQ feedback information; performing a second listen-before-talk (LBT) procedure based on a first LBT procedure failing prior to a start of the PSFCH time resource; and transmitting, to a transmitter UE and using a medium access control control element (MAC CE) associated with a physical sidelink shared channel (PSSCH), the first SL HARQ feedback information based on the second LBT procedure being successful.
Aspect 32: The method of Aspect 31, wherein transmitting the first SL HARQ feedback information using the MAC CE comprises transmitting the first SL HARQ feedback information using the MAC CE based on a second stage SCI (SCI-2) communication associated with the PSSCH comprising a destination identifier (ID) corresponding to the transmitter UE.
Aspect 33: The method of either of claim 31 or 32, wherein a second stage SCI (SCI-2) communication associated with the PSSCH comprises a destination identifier (ID) corresponding to an additional UE.
Aspect 34: The method of Aspect 33, wherein the SCI-2 communication includes a decode indication.
Aspect 35: The method of any of Aspects 31-34, further comprising transmitting, with the MAC CE, a data communication associated with the PSSCH.
Aspect 36: The method of any of Aspects 31-34, further comprising transmitting, with the MAC CE, a dummy data communication associated with the PSSCH.
Aspect 37: A method of wireless communication performed by a transmitter user equipment (UE), comprising: transmitting, to a receiver UE, first sidelink control information (SCI) comprising a first dynamic sidelink (SL) hybrid automatic repeat request (HARQ) timing offset indication corresponding to a physical sidelink feedback channel (PSFCH) time resource allocated for transmitting, over an unlicensed SL channel and outside of a channel occupancy time (COT), first SL HARQ feedback information associated with a first data transmission scheduled within the COT, the first dynamic HARQ timing offset indication comprising an applicable offset value, the applicable offset value comprising a value that is applicable for indicating a timing for transmitting SL HARQ feedback information; and receiving, using a medium access control control element (MAC CE) associated with a physical sidelink shared channel (PSSCH), the first SL HARQ feedback information based on a successful LBT procedure associated with the receiver UE.
Aspect 38: The method of Aspect 37, wherein receiving the first SL HARQ feedback information using the MAC CE comprises receiving the first SL HARQ feedback information using the MAC CE based on a second stage SCI (SCI-2) communication associated with the PSSCH comprising a destination identifier (ID) corresponding to the transmitter UE.
Aspect 39: The method of either of claim 37 or 38, wherein a second stage SCI (SCI-2) communication associated with the PSSCH comprises a destination identifier (ID) corresponding to an additional UE.
Aspect 40: The method of Aspect 39, wherein the SCI-2 communication includes a decode indication.
Aspect 41: The method of any of Aspects 37-40, further comprising receiving, with the MAC CE, a data communication associated with the PSSCH.
Aspect 42: The method of any of Aspects 37-40, further comprising receiving, with the MAC CE, a dummy data communication associated with the PSSCH.
Aspect 43: The method of any of Aspects 1-42, wherein the applicable offset value comprises a positive integer and the inapplicable offset value comprises a value other than a positive integer.
Aspect 44: An apparatus for wireless communication at a device, comprising a processor; memory coupled with the processor; and instructions stored in the memory and executable by the processor to cause the apparatus to perform the method of one or more of Aspects 1-16 or 43.
Aspect 45: A device for wireless communication, comprising a memory and one or more processors coupled to the memory, the one or more processors configured to perform the method of one or more of Aspects 1-16 or 43.
Aspect 46: An apparatus for wireless communication, comprising at least one means for performing the method of one or more of Aspects 1-16 or 43.
Aspect 47: A non-transitory computer-readable medium storing code for wireless communication, the code comprising instructions executable by a processor to perform the method of one or more of Aspects 1-16 or 43.
Aspect 48: A non-transitory computer-readable medium storing a set of instructions for wireless communication, the set of instructions comprising one or more instructions that, when executed by one or more processors of a device, cause the device to perform the method of one or more of Aspects 1-16 or 43.
Aspect 49: An apparatus for wireless communication at a device, comprising a processor; memory coupled with the processor; and instructions stored in the memory and executable by the processor to cause the apparatus to perform the method of one or more of Aspects 17-30 or 43.
Aspect 50: A device for wireless communication, comprising a memory and one or more processors coupled to the memory, the one or more processors configured to perform the method of one or more of Aspects 17-30 or 43.
Aspect 51: An apparatus for wireless communication, comprising at least one means for performing the method of one or more of Aspects 17-30 or 43.
Aspect 52: A non-transitory computer-readable medium storing code for wireless communication, the code comprising instructions executable by a processor to perform the method of one or more of Aspects 17-30 or 43.
Aspect 53: A non-transitory computer-readable medium storing a set of instructions for wireless communication, the set of instructions comprising one or more instructions that, when executed by one or more processors of a device, cause the device to perform the method of one or more of Aspects 17-30 or 43.
Aspect 54: An apparatus for wireless communication at a device, comprising a processor; memory coupled with the processor; and instructions stored in the memory and executable by the processor to cause the apparatus to perform the method of one or more of Aspects 31-36 or 43.
Aspect 55: A device for wireless communication, comprising a memory and one or more processors coupled to the memory, the one or more processors configured to perform the method of one or more of Aspects 31-36 or 43.
Aspect 56: An apparatus for wireless communication, comprising at least one means for performing the method of one or more of Aspects 31-36 or 43.
Aspect 57: A non-transitory computer-readable medium storing code for wireless communication, the code comprising instructions executable by a processor to perform the method of one or more of Aspects 31-36 or 43.
Aspect 58: A non-transitory computer-readable medium storing a set of instructions for wireless communication, the set of instructions comprising one or more instructions that, when executed by one or more processors of a device, cause the device to perform the method of one or more of Aspects 31-36 or 43.
Aspect 59: An apparatus for wireless communication at a device, comprising a processor; memory coupled with the processor; and instructions stored in the memory and executable by the processor to cause the apparatus to perform the method of one or more of Aspects 37-42 or 43.
Aspect 60: A device for wireless communication, comprising a memory and one or more processors coupled to the memory, the one or more processors configured to perform the method of one or more of Aspects 37-42 or 43.
Aspect 61: An apparatus for wireless communication, comprising at least one means for performing the method of one or more of Aspects 37-42 or 43.
Aspect 62: A non-transitory computer-readable medium storing code for wireless communication, the code comprising instructions executable by a processor to perform the method of one or more of Aspects 37-42 or 43.
Aspect 63: A non-transitory computer-readable medium storing a set of instructions for wireless communication, the set of instructions comprising one or more instructions that, when executed by one or more processors of a device, cause the device to perform the method of one or more of Aspects 37-42 or 43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a receiver user equipment (UE), comprising:
receiving first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information;
receiving second SCI comprising a second dynamic SL HARQ timing offset indication comprising an applicable offset value, the applicable offset value comprising a value that is applicable for indicating a timing for transmitting SL HARQ feedback information; and
transmitting, using a feedback time resource that is associated with the applicable offset value, first SL HARQ feedback information associated with the first SCI.

2. The method of claim 1, further comprising transmitting, using the feedback time resource, second SL HARQ feedback information associated with the second SCI.

3. The method of claim 1, wherein transmitting the first SL HARQ feedback information using the feedback time resource comprises transmitting the first SL HARQ feedback information using the feedback time resource based on a first source identifier (ID) associated with the first SCI being equal to a second source ID associated with the second SCI.

4. The method of claim 1, wherein transmitting the first SL HARQ feedback information using the feedback time resource comprises transmitting the first SL HARQ feedback information using the feedback time resource based on a first source identifier (ID) associated with the first SCI being equal to a second source ID associated with the second SCI and a first destination ID associated with the first SCI being equal to a second destination ID associated with the second SCI.

5. The method of claim 1, wherein receiving the second SCI comprises receiving an SL communication that includes the second SCI and data.

6. The method of claim 1, wherein receiving the second SCI comprises receiving a physical sidelink shared channel (PSSCH) communication in a corresponding slot, the PSSCH communication comprising only the second SCI.

7. The method of claim 1, wherein receiving the second SCI comprises receiving a physical sidelink shared channel (PSSCH) communication in a corresponding slot, the PSSCH communication comprising the second SCI and the first data transmission.

8. The method of claim 1, wherein the second SCI is associated with an SL connection between a transmitter UE and an additional UE.

9. The method of claim 8, wherein a first destination identifier (ID) associated with the first SCI is different from a second destination ID associated with the second SCI.

10. The method of claim 8, wherein the first SCI includes a physical sidelink feedback channel (PSFCH) resource indication (PRI) that indicates a set of physical resource blocks associated with the first SL HARQ feedback information.

11. The method of claim 10, further comprising obtaining a resource partition indication associated with the PSFCH.

12. The method of claim 11, wherein obtaining the resource partition indication comprises at least one of accessing a memory of the receiver UE or receiving a radio resource control message.

13. The method of claim 10, wherein a first destination identifier (ID) associated with the first SCI is different from a second destination ID associated with the second SCI, wherein the first SCI indicates a first physical sidelink feedback channel (PSFCH) resource indication (PRI) that indicates a first set of physical resource blocks associated with the first SL HARQ feedback information, and wherein the second SCI indicates a second PRI that indicates a second set of physical resource blocks associated with second SL HARQ feedback information corresponding to the SL connection between the transmitter UE and the additional UE.

14. The method of claim 1, wherein a first HARQ codebook is associated with the first SL HARQ feedback information and a second HARQ codebook is associated with second SL HARQ feedback information associated with the second SCI.

15. The method of claim 14, wherein the second HARQ codebook comprises a semi-static HARQ codebook or a dynamic HARQ codebook, and wherein the second SCI comprises a first detected SCI having an applicable offset indication.

16. The method of claim 14, wherein the second HARQ codebook comprises an enhanced dynamic HARQ codebook, and wherein the second SCI comprises a first detected SCI having an applicable offset indication based on the first detected SCI indicating a physical sidelink shared channel (PSSCH) group index that is equal to a PSSCH group index indicated by the first SCI.

17. The method of claim 1, wherein the applicable offset value comprises a positive integer and the inapplicable offset value comprises a value other than a positive integer.

18. A method of wireless communication performed by a transmitter user equipment (UE), comprising:
transmitting first sidelink control information (SCI) comprising a first dynamic sidelink (SL) hybrid automatic repeat request (HARQ) timing offset indication for transmitting first SL HARQ feedback information associated with a first data transmission, the first dynamic HARQ timing offset indication comprising an inapplicable offset value, the inapplicable offset value comprising a value that is not applicable for indicating a timing for transmitting SL HARQ feedback information;
transmitting second SCI comprising a second dynamic SL HARQ timing offset indication comprising a numerical offset value, the numerical offset value comprising a value that is applicable for indicating a timing for transmitting SL HARQ feedback information; and
receiving, using a feedback time resource that is associated with the applicable offset value, first SL HARQ feedback information associated with the first SCI.

19. The method of claim 18, further comprising receiving, using the feedback time resource, second SL HARQ feedback information associated with the second SCI.

20-32. (canceled)

33. A method of wireless communication performed by a receiver user equipment (UE), comprising:
receiving first sidelink control information (SCI) comprising a first dynamic sidelink (SL) hybrid automatic repeat request (HARQ) timing offset indication corresponding to a physical sidelink feedback channel (PSFCH) time resource allocated for transmitting, over an unlicensed SL channel and outside of a channel occupancy time (COT), first SL HARQ feedback information associated with a first data transmission scheduled within the COT, the first dynamic HARQ timing offset indication comprising an applicable offset value, the applicable offset value comprising a value that is applicable for indicating a timing for transmitting SL HARQ feedback information;
performing a second listen-before-talk (LBT) procedure based on a first LBT procedure failing prior to a start of the PSFCH time resource; and
transmitting, to a transmitter UE and using a medium access control control element (MAC CE) associated with a physical sidelink shared channel (PSSCH), the first SL HARQ feedback information based on the second LBT procedure being successful.

34-44. (canceled)
